(19) United States
(12) Patent Application Publication
(10) Pub. No.: US 2002/0069407 A1
(43) Pub. Date: Jun. 6, 2002

(54) System and method for reporting counted impressions

(75) Inventors: Mark Fagnani, Watertown, MA (US); Terri Swartz, Marlboro, MA (US); Chaitanya Kanojia, Newton, MA (US); Kirk Cameron, Upton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Navic Systems, Incorporated, Newton, MA (US)

(21) Appl. No.: 09/873,784

(22) Filed: Jun. 4, 2001

Related U.S. Application Data
(60) Provisional application No. 60/253,351, filed on Nov. 28, 2000.

(51) Int. Cl. H04N 7/025

(52) U.S. Cl. 725/35; 725/46

(57) ABSTRACT

A system for reporting counted impressions in a network device. The system includes a data warehouse which collects event data pertaining to viewership history on the network device. Through a user interface, such as a web browser, a user can retrieve information about the counted impressions of the network device which displayed specific promotions. The event data may pertain, for example, to channel change events, channel surfing behavior of the viewer, time events, connections to peripherals, network locations of the network device, viewing behavior of the viewer, and subsequent event data after a promotion was displayed. A trigger may be embedded in the promotion such that when the promotion is displayed an impression is counted.

### RELATED APPLICATION

This application claims the benefit of U.S. Provisional Application No. 60/253,351, filed on Nov. 28, 2000. The entire teachings of the above application is incorporated herein by reference.

### BACKGROUND OF THE INVENTION

At the present time, most data network devices located in the residences include some type of personal computer. Typically, these personal computers are used to connect to Internet Service Providers over dial-up connections to execute application programs such as email clients and Web browsers that utilize the global Internet to access text and graphic content. Increasingly, the demand is for multimedia content, including audio and video, to be delivered over such networks. However, the backbone architecture of purely data networks, especially those designed for use with the telephone network, were not originally designed to handle such high data rates.

The trend is towards a more ubiquitous model where the network devices in the home will be embedded systems designed for a particular function or purpose. This has already occurred to some degree. Today, for example, cable television (CATV) network set-top boxes typically have limited data communication capabilities. The main function of the data devices is to handle channel access between residential users and a head end or server on the cable TV network.

However, it is estimated that the worldwide market for Internet appliances such as digital set-top boxes and Web-connected terminals will reach $17.8 billion in 2004, and millions of such digital set-top boxes have already been deployed. Increasingly, advertisers and content providers view the cable set-top as the first platform of choice for widespread delivery of a suite of intelligent content management and distribution services.

In the future, the functionality offered by these set-top boxes or other embedded platforms, such as a game system, will be expanded. For example, they may offer Internet browsing capabilities and e-commerce serving capabilities. Moreover, it is anticipated that common-household appliances will also have network functionality, in which they will be attached to the network to automate various tasks.

### SUMMARY OF THE INVENTION

The digital set top box provides certain interesting functionalities, such as the ability to collect data, such as a log of the channels watched over time, and other events. The set top box can be designed and programed to report this information to a central location. At the central location, this data can be aggregated for many hundreds of thousands of users. This information, when coupled with other information such as demographics, can then be used by advertisers and service providers to target individuals or blanket defined market segments with promotions, advertisements, and content. The digital delivery of promotions can then allow for impulse responses yielding immediate increases in revenues.

To effectively target specific network devices with promotions, a user, such as an advertiser, may want to inquire about the counted impressions of multiple network devices.

The present invention implements a system for reporting counted impressions in one or more network devices.

Specifically, the system includes a data warehouse which collects event data pertaining to viewership history on the network devices. Through a user interface, such as a web browser, a user can retrieve information about the counted impressions of the network devices which displayed specific promotions. The data may be correlated with a promotions schedule database.

The event data may pertain, for example, to channel change events, channel surfing behavior of the viewer, time events, connections to peripherals, network locations of the network devices, viewing behavior of the viewer, and subsequent event data after a promotion was displayed.

A trigger may be embedded in the promotion such that when the promotion is displayed an impression is counted. Further, the system may be configurable in terms of acceptance and rejection events of the promotions. These may be based on thresholds configured dynamically. The configuration may be performed for a selected network device. Alternatively, the configuration may be performed for a group of network devices. The configuration may be based on demographics or viewership patterns of the viewers, or on the physical capabilities of the network devices.

In another aspect of the invention, a method for reporting counted impressions in at least one network device includes collecting event data pertaining to the network device, correlating the data with a promotions schedule database, and providing a user interface for querying the data warehouse. The method enables a user to determine the counted impressions of the network device which displayed specific promotions.

The implementation of a system and method for reporting counted impressions in this manner assists network operators to cost effectively support the advanced features of the set top box, such as to provide targeted promotion and digital content distribution services. This enables network operators to generate new revenues and provide a richer interactive environment for consumers.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a block diagram illustrating a set top box attached to a television displaying a promotion in a full-screen electronic program guide according to one embodiment of the present invention.

FIG. 1B is a block diagram illustrating the television of FIG. 1A displaying a promotion in a partial-screen electronic program guide.

FIG. 2 is a schematic diagram illustrating the interaction between a server system and an embedded client system according to the invention.

FIG. 3 is a block diagram illustrating the interaction between the server system of FIG. 2 and a third party browser.

FIG. 4A is a block diagram illustrating a process for inquiring about viewership profiles generated by the server system of FIG. 2.

FIG. 4B is a block diagram illustrating a process for reporting counted impressions determined by the server system of FIG. 2.

FIG. 5 is a process flow diagram illustrating how impressions are counted in a system implementing embedded triggers in the promotions.

### DETAILED DESCRIPTION OF THE INVENTION

A description of preferred embodiments of the invention follows. Embodiments of the targeted promotion delivery system allow advertisers and service providers the ability to effectively utilize a multimedia network for targeting promotions at viewers through network devices. Network devices are targeted for promotion delivery based on device usage statistics collected from these devices and on demographic data. The promotion delivery system can target network devices in varying degrees of granularity from a single network device to entire market segments. Furthermore, the promotion delivery system is designed to ensure efficient use of network bandwidth when delivering promotions to prevent network congestion. The system can be implemented over a variety of multimedia networks containing large populations of network devices, such as television set top boxes, Internet phones, and other similar network appliances.

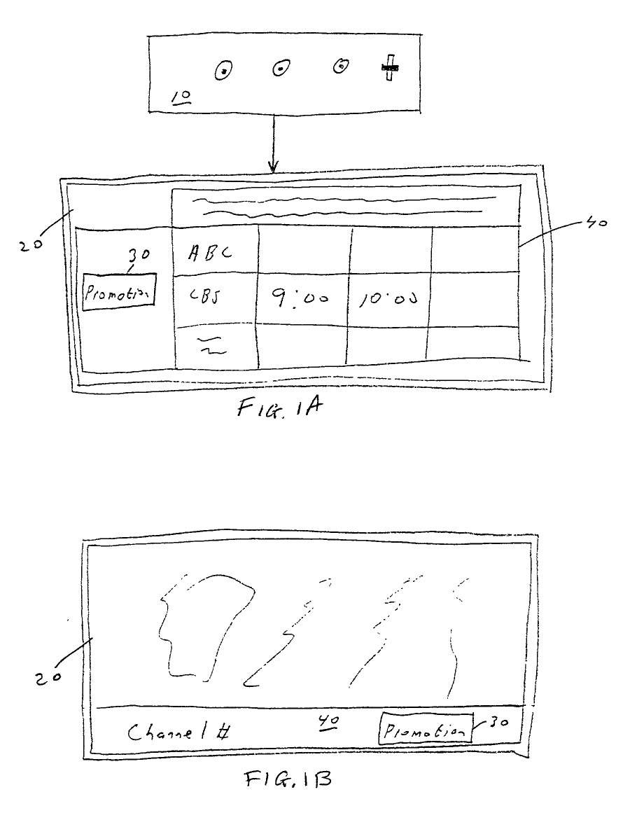

FIG. 1A is a diagram illustrating a video display system with an active promotion according to one embodiment. Promotions include promotional content that may be presented in various multimedia formats including audio, video, graphics or icons, and Internet hyperlinks. Promotions are used to advertise goods and services, promote events, or present other commercial or non-commercial information.

Referring to FIG. 1A, the video display system 1 includes network device or set top box 10 connected to a respective video display 20, such as a television. Promotions 30 typically include promotional content that may be presented in various multimedia formats including standard audio visual clips, but also computer graphics, icons, or Internet hyperlinks. Promotions are used to advertise goods and services, promote events, or present other commercial or non-commercial information. One or more promotions 30 may be simultaneously active within the video display 20 and may be displayed in different ways. For example, promotions 30 can be presented on electronic program guides, channel information bars 40 (FIG. 1B), or by overlaying video broadcast programming. Some active promotions allow user interaction such as linking to e-commerce web-sites via hyperlink connections or direct communication with the server subsystem to obtain additional software, such as device drivers, video games, or other application software.

The promotions 30 can be stored locally or in a stream in the network that is viewed as a virtual channel or a dedicated channel and located using a local moniker. The promotions 30 can be displayed as banners, hot spots, or full motion streams, such as personal video recorders. The promotions 30 could be for a video on demand (VOD) movie, commerce IPPV, an offer for a product, a pay for view event, and walled gardens. Although the promotions 30 in FIGS. 1A and 1B cover only a portion of the viewable screen area, the promotions may cover the entire screen area. Further, there may be multiple promotions 30 displayed on the video device 20, each promotion 30 being independently selectable. The multiple promotions 30 may cover a portion or the entire viewing screen area of the video device 20. Clicking on or accepting the promotion 30 by the viewer may cause the network device 10 to tune away from channel on which the promotion is displayed.

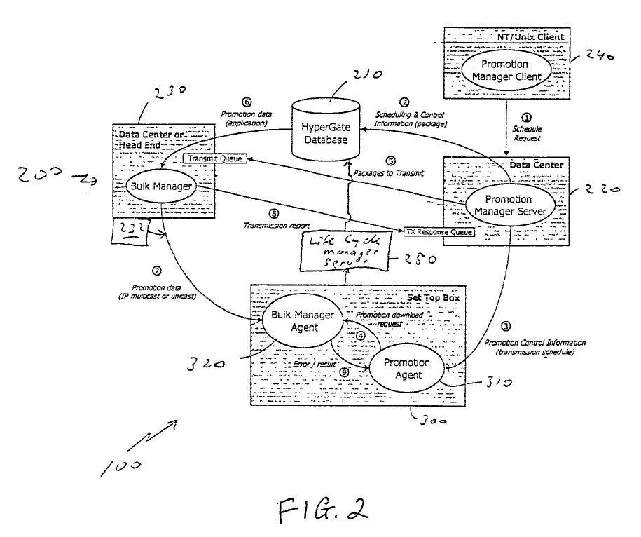

FIG. 2 is a high-level system diagram illustrating a targeted promotion delivery system for a multimedia network according to one embodiment. The system 100 includes a promotion server subsystem 200 and a promotion agent subsystem 300 embedded within each of the network devices. The promotion server subsystem 200 and the promotion agent subsystems 300 communicate with each other through a combination of application-level messaging and serialized bulk data transmissions.

A life-cycle manager server 250 periodically collects viewer usage data from the promotion agent subsystem 300 of each of the network devices to generate viewership profiles. In television networks, the data collected by the life-cycle manager server 250 may include tuner data (i.e., a history of channels watched) and responses to past promotions. This history is kept on a relatively fine time scale, such as five seconds, or any other time period set by the user. In this way, it can be determined how long a particular promotion was deployed, or even which portions of a promotion or video program were viewed.

In more detail regarding promotion delivery, the promotion server subsystem 200 includes a database 210, a scheduler or promotion manager server 220, a bulk data server 230, and a promotion manager client 240 interfacing with the life-cycle manager server 250. The bulk data server is typically located at a central location in the multimedia network at a data center, head end, or divided between the two depending on the density and population of devices. The other components, the database 210, the promotion manager server 220, and the promotion manager client 240, are located at the data center.

The life-cycle manager server 250 of the promotion server subsystem 200 generate viewership profiles for each of the network devices from the collected data using a variety of statistical models. The viewership profiles are then used to associate each multimedia content viewing device with promotion groups.

Promotion groups are collections of network devices whose individual viewership profiles match membership criterion describing a particular demographic or viewership history. For example, a promotion group may be demographically based, i.e., “married women in their 30's with more than one school age child and a household income of at least $100,0000,” or based on viewership history, i.e., “tends to watch the Golf Channel on Sunday afternoon.” The membership criterion for a promotion group may be specified broadly to target an entire market segment (e.g., sports enthusiasts) or narrowly to target a niche portion of a market segment (e.g., badminton sport enthusiasts). Furthermore, membership within a promotion group can change over time in response to updates to the viewership profiles. Therefore, the promotion delivery system is adaptable to changes in viewer usage or viewership patterns by making adjustments to promotion groups. Promotion groups are described in more detail in U.S. Patent Application Attorney Docket No. 2657.2012-001, filed herewith, the contents of which are herein incorporated by referenced.

Promotions are then scheduled for delivery to specific promotion groups. A promotion is scheduled for delivery to a promotion group by an advertiser or service provider entering a scheduling request for a promotion via the promotion manager client 240, or a promotion web console interfaced with an intranet and/or the Internet. The promotion manager server 220 packages the promotion for delivery and stores it in the database 210. Later, the package information is read from the database 210 and used to create customized transmission schedules that specify when and how each of the network devices that is associated with a promotion group is to receive it.

The promotion agent subsystem 300 embedded in each of the network devices includes a promotion agent 310 and a bulk data agent 320. Upon receipt of the transmission schedule messages, the promotion agent 310 processes each schedule entry and waits for the bulk data agent 320 to deliver each promotion identified in the transmission schedule. The bulk data agent 320 then handles the reception of the promotions from the scheduled data transmission as specified in the promotion download requests. In one embodiment, the bulk data agent 320 tunes into a multicast data transmission stream at a specified time and channel or network address specified in the transmission schedule.

The promotion manager server 220 extracts the promotion package from the database 210 and converts it into a transmission request that is sent to the bulk data server 230. The bulk data server 230 fetches the promotions from the database 210 that are identified in the transmission request message, and transmits them via multicast or broadcast transmission depending on transmission control data specified in the transmission request. The promotions can also be stored in the bulk data server 230 or in a cache.

Once the promotions have been successfully delivered, the promotions are activated at the network devices as specified in promotion control data of the transmission schedules. Promotion activation may be event, time, or channel driven. Promotion activation may also occur because of some series of viewer events, for example, some pattern of channel surfing by the viewer may activate a promotion.

In addition, Navic triggers or triggers may be embedded in broadcast streams such as Advanced Television Enhancement Forum (ATVEF), Vertical Blanking Interval (VBI), or in Moving Pictures Experts Group (MPEG) data streams. For example, upon the occurrence of certain events, the bulk data server 230 uses a trigger inserter 232 to insert a trigger or triggers into the broadcast stream transmitted to the set top box 10.

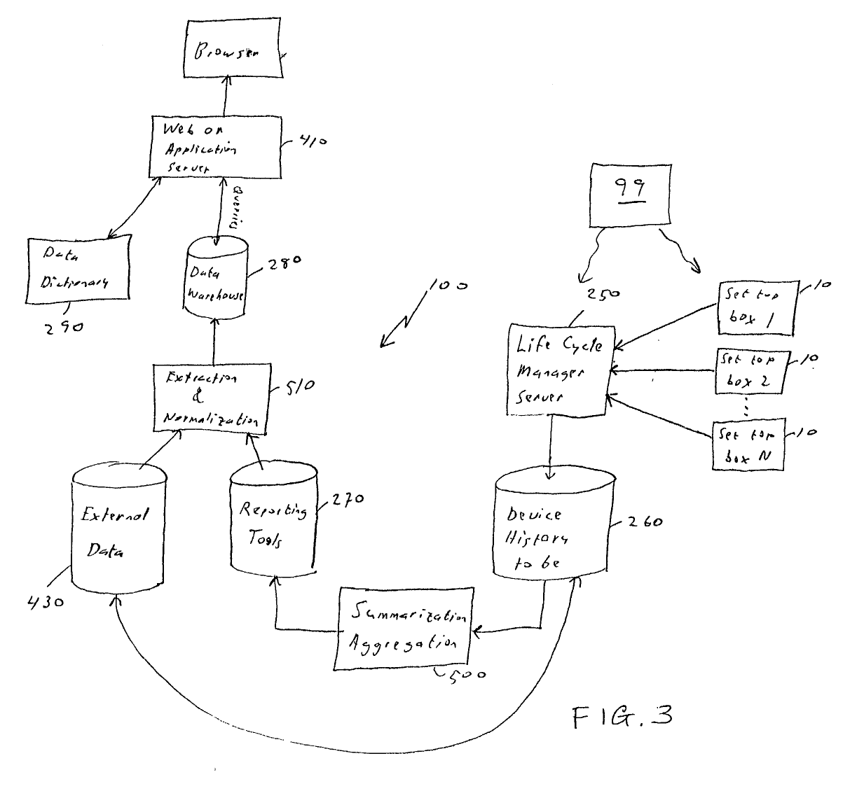

FIG. 3 shows the server system 100 and the set top boxes 10 interacting with a web or application server 410, which is accessed through a browser 420 by, for example, an advertiser. Each set top box may accommodate multiple viewers. The web or application server 410, via the browser 420, enables an advertiser to access viewership profiles associated with the multimedia content devices, such as the set top box 10. Generation of viewership profiles are described in more detail in U.S. Patent Application Attorney Docket No. 2657.2003-001, entitled “USING VIEWERSHIP PROFILES FOR TARGETED PROMOTION DEPLOYMENT,” filed herewith, the contents of which are herein incorporated by reference.

In addition to the components described in reference to FIG. 2, the server system 100 also includes a device history database 260, a reporting tools 270, a data warehouse 280, and a data dictionary 290. The life cycle manager server 250 collects the viewership history of the set top boxes 10 and generates viewership profiles. The viewership history includes the activities of one or more viewers who watch programs tuned to by the set top boxes 10, such as the channels tuned in, the time the channels were tuned in, the time the channels were tuned off, whether a peripheral is connected to the set top box 10, the network location of the network devices, the physical capabilities of the network devices, acceptance responses to promotions, time spent on a particular viewer activity, or other viewer behavior such as scrolling through the program guide. Acceptance of a promotion may lead to another promotion, a channel change or a URL, which are also recorded in the viewership history. The viewership history may also include the geographic location of the set top box 10 as well as the demographics of the individual viewers of the set top box 10. The events recorded in the viewership history may be compressed in a bit mask and transmitted to the life cycle manager server 250. In the embodiment shown in FIG. 3, the life cycle manager server 250 collects such data and transmits it to the device history database 260.

The data from the device history database 260 is summarized and aggregated in a step 500 and then transmitted to a reporting tools database 270. The reporting tools database 270 organizes the data in a structure which facilitates publication, generation, and distribution of the data. The information from reporting tools database 270 is combined with external data 430 provided by different vendors, or commercial services. Because various vendors may report data, such as income data, differently, for example, on a percentile basis or on actual income levels, an extraction and normalization step 510 normalizes the data before it is transmitted to the data warehouse 280, which is accessible to third parties.

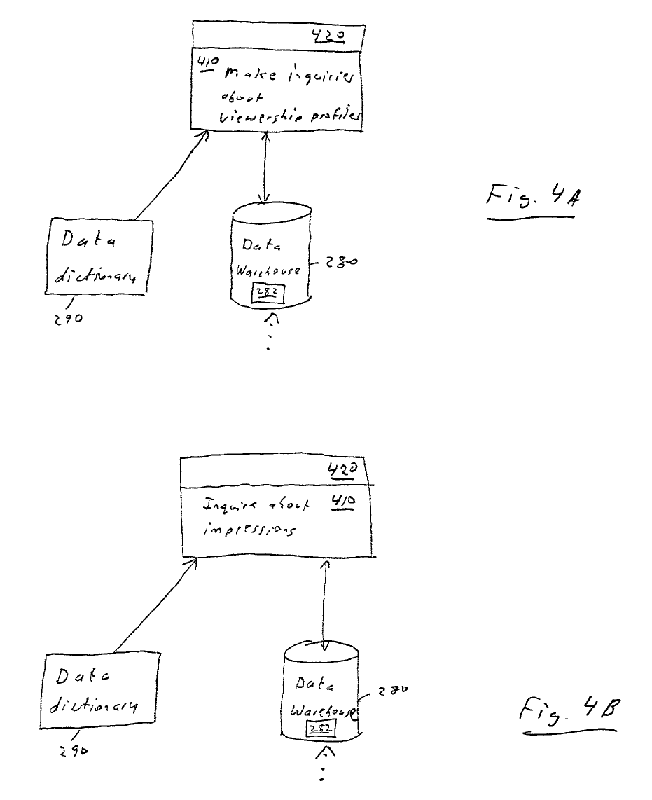

FIG. 4A illustrates the interaction of an advertiser with the system 100. The data dictionary 290 provides a user friendly description of the data available in the data warehouse 280 such as the promotion schedule database 282. Thus from the browser 420 the advertiser can make inquiries through the web server 410 as to the viewership profiles associated with each set top box 10. For example, the advertiser can make the inquiry “what were all the households having a particular annual income range who watched a particular ad on specified dates?”

Alternatively, as illustrated in FIG. 4B, a third party can inquire about the impressions on each set top box 10. For example, an initial inquiry can be made such as “which set top boxes were actually tuned to a particular promotion?” And then the advertiser can make the additional inquiry “who switched away from the promotion while it was being displayed, or for which promotions did the viewer stop and watch or interact with?” That is, the system 100 can provide the advertiser with information related to “channel surfing” behavior of the viewers, as well as the effectiveness of the promotions, by counting the number of actual impressions and their duration.

Additionally, the third party may inquire “what promotions were viewed?”, “when where were the promotions displayed?”, and “what happened when the promotions were displayed?”. As to what happened, the third party may inquire “did the promotion acceptance result in a channel change, a change to a URL, a different promotion, or an acceptance tag such as Yes/NO, and how did the viewer respond to the acceptance tag?”

The system 100 is configurable in terms of acceptance and rejection events. These event may be based on thresholds configured dynamically through a central console 99 of the system 100. The system may be configured for a selected network device or a group of network devices based on the demographics of the viewers, the physical capabilities of the network devices, such as the memory of the device or the transport type of the device, and/or the viewership patterns of the viewers.

As to which promotions were viewed, the promotion schedule can be correlated with the viewership history of the set top box 10. Alternatively, as mentioned above, a trigger may be embedded in the promotion so that when the promotion is viewed the impression is counted. The use of embedded triggers in the promotion facilitates counting the impressions without correlating the promotion with the promotion schedules.

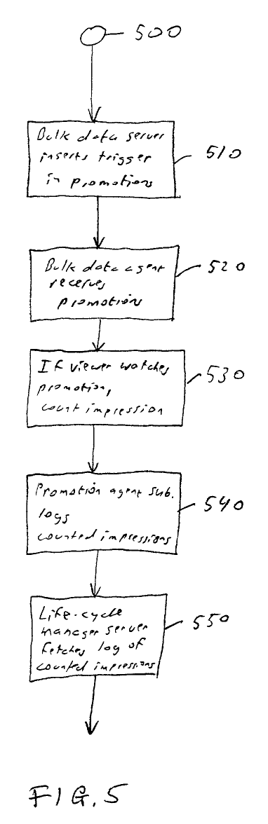

Turning attention now to FIG. 5, an embodiment of the process for inserting triggers will be described. Initially the system is in an idle state 500. After some period of time, a state 510 is entered which occurs a short time before a commercial break. In this state the bulk data server 230 causes an asset trigger to be inserted in the broadcast or video stream, for example, in a line 21 broadcast stream. The trigger may be sent in the Vertical Blanking Interval (VBI) as defined in the ATVEF specification, or in other ways. For example, the trigger may be placed in the private data segments of an MPEG stream. In any event, the asset trigger contains text character, or other data indicating general information identifying the promotion.

Next, in a state 520, the bulk data server 230 delivers the promotions to the bulk data agent 320 according to the transmission schedule messages processed by the promotion agent 310.

Next, in a state 530, if a viewer watches a particular promotion at the set top box 10, the trigger embedded in that promotion causes an impression to be counted.

Over a period of time, in a state 540, the promotion agent subsystem logs the counted impressions which identifies the various promotions viewed on the set top box.

Periodically, in a state 550, the life-cycle manager server 250 fetches the counted impressions associated with the set top box 10. At this point, the data can be used as described above (FIG. 4B) by an advertiser, for example, who may want to inquire about the impressions of each set top box 10.

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for reporting counted impressions in at least one network device, comprising:
a data warehouse for collecting event data pertaining to the network device; and
a user interface for querying the data warehouse to enable a user to determine the counted impressions of the network device which displayed specific promotions.

2. The system of claim 1, wherein the event data is correlated with a promotions schedule database.

3. The system of claim 2, wherein the event data is correlated with demographics.

4. The system of claim 2, wherein the event data includes channel change events which occur after the promotion is displayed.

5. The system of claim 2, wherein the correlation provides information as to whether a channel surfer stopped surfing after a promotion was displayed.

6. The system of claim 1, wherein the event data of each network device includes a channel on the network device.

7. The system of claim 1, wherein the event data includes a time at which the network device was tuned to the channel.

8. The system of claim 1, wherein the event data includes a time at which the network device was tuned away from the channel.

9. The system of claim 1, wherein the event data includes a connection between the network device and a peripheral.

10. The system of claim 1, wherein the event data includes the viewing behavior of a viewer.

11. The system of claim 10, wherein the viewing behavior includes scrolling through a program guide.

12. The system of claim 10, wherein the viewing behavior includes promotion acceptances.

13. The system of claim 12, wherein after the promotion is accepted another promotion is displayed such that impressions of subsequent promotions are counted.

14. The system of claim 12, wherein the viewing behavior includes time spent on a viewer activity.

15. The system of claim 1, wherein the network device periodically sends the event data to the data warehouse.

16. The system of claim 1, wherein a trigger is embedded in the promotion such that when the promotion is viewed an impression is counted.

17. The system of claim 1, wherein the event data is represented in a compressed manner using a bit mask.

18. The system of claim 1, wherein the event data includes receipt of broadcast triggers.

19. The system of claim 18, wherein the broadcast triggers are transmitted on a line 21.

20. The system of claim 1, wherein the event data includes receipt of triggers in MPEG streams.

21. The system of claim 1, wherein the system is configurable in terms of acceptance and rejection events of the promotions based on thresholds configured dynamically through a central console.

22. The system of claim 21, wherein the configuration is performed for a selected network device.

23. The system of claim 21, wherein the configuration is performed for a group of network devices.

24. The system of claim 23, wherein the configuration is based on demographics of the viewers.

25. The system of claim 23, wherein the configuration is based on viewership patterns of the viewers.

26. The system of claim 23, wherein the configuration is based on the physical capabilities of the network devices.

27. The system of claim 1, wherein the event data includes the scheduled time for the promotions.

28. The system of claim 1, wherein the event data includes the network location of the network devices.

29. The system of claim 1, wherein the event data includes subsequent event data after a promotion was displayed.

30. The system of claim 29, wherein the subsequent data includes the display of a URL.

31. The system of claim 29, wherein the subsequent data includes additional channels to which the network device was tuned to.

32. The system of claim 29, wherein the subsequent data includes the display of acceptance tags, and the response of the viewer to the display of the tags.

33. The system of claim 1, wherein the counted impressions is the number of network devices which displayed specific promotions.

34. A method for reporting counted impressions in at least one network device, comprising the steps of:
collecting event data pertaining to the network device;
correlating the data with a promotions schedule database; and
providing a user interface for querying the data warehouse to enable a user to determine the counted impressions of the network device which displayed specific promotions.

35. The method of claim 34, wherein the step of correlating includes correlating with demographics data.

36. The method of claim 34, wherein the event data includes channel change events after the display of the promotion.

37. The method of claim 34, wherein the step of correlating includes providing information as to whether a channel surfer stopped surfing after the promotion was displayed.

38. The method of claim 34, wherein the event data of each network device includes a channel on the network device.

39. The method of claim 34, wherein the event data includes a time at which the network device was tuned to the channel.

40. The method of claim 34, wherein the event data includes a time at which the network device was tuned away from the channel.

41. The method of claim 34, wherein the event data includes a connection between the network device and a peripheral.

42. The method of claim 34, wherein the event data includes the viewing behavior of a viewer.

43. The method of claim 42, wherein the viewing behavior includes scrolling through a program guide.

44. The method of claim 42, wherein the viewing behavior includes promotion acceptances.

45. The method of claim 44, wherein the step of collecting includes recording impressions of subsequent promotions caused by promotion acceptances.

46. The method of claim 42, wherein the viewing behavior includes time spent on a viewer activity.

47. The method of claim 34, further comprising the step of periodically sending the event data to the data warehouse.

48. The method of claim 34, wherein the step of collecting includes counting an impression caused by a trigger embedded in a video stream.

49. The method of claim 34, wherein the event data is represented in a compressed manner using a bit mask.

50. The method of claim 34, wherein the event data includes receipt of broadcast triggers.

51. The method of claim 50, wherein the broadcast triggers are transmitted on a line 21.

52. The method of claim 34, wherein the step of collecting includes receiving triggers in MPEG streams.

53. The method of claim 34, further comprising the step of configuring the system in terms of promotion acceptance and rejection events of the promotions based on thresholds configured dynamically through a central console.

54. The method of claim 53, wherein the step of configuring includes configuring for a selected network device.

55. The method of claim 53, wherein the step of configuring includes configuring for a group of network devices.

56. The method of claim 55, wherein the configuration is based on demographics of the viewers.

57. The method of claim 55, wherein the configuration is based on the viewership patterns of the viewers.

58. The method of claim 55, wherein the configuration is based on the physical capabilities of the network devices.

59. The method of claim 34, wherein the event data includes the scheduled display time for the promotions.

60. The method of claim 34, wherein the event data includes the network locations of network devices.

61. The method of claim 34, wherein the step of collecting includes collecting subsequent event data after a promotion was displayed.

62. The method of claim 61, wherein the subsequent data includes a display of a URL.

63. The method of claim 61, wherein the subsequent data includes additional channels to which the network device was tuned to.

64. The method of claim 61, wherein the subsequent data includes the display of acceptance tags, and the response of the viewer to the display of the tags.

65. The method of claim 34, wherein the counted impressions is the number of network devices which displayed specific promotions.
